(19) United States
(12) Patent Application Publication
(10) Pub. No.: US 2026/0024173 A1
(43) Pub. Date: Jan. 22, 2026

(54) SYSTEM AND METHOD FOR GENERATING IMAGES OF AN EYE

(71) Applicant: Alcon Inc., Fribourg (CH)

(72) Inventors: Sinchan BHATTACHARYA, Kent, WA (US); Robert ANGELOPOULOS, San Jose, CA (US); Bryan Adams STANFILL, Mansfield, TX (US); Shruti SIVA KUMAR, Valencia, CA (US); George Hunter PETTIT, Fort Worth, TX (US)

(21) Appl. No.: 19/201,076

(22) Filed: May 7, 2025

Related U.S. Application Data
(60) Provisional application No. 63/674,102, filed on Jul. 22, 2024.

(51) Int. Cl. G06T 5/60

(52) U.S. Cl. CPC G06T 5/60; G06T 2207/10072; G06T 2207/10132; G06T 2207/20081; G06T 2207/20172; G06T 2207/30041

(57) ABSTRACT

A method of augmenting an eye image includes obtaining a first training image of a first type and applying a first function to obtain a first generated image of a second type. A second function is applied to the first generated image to obtain a second generated image of the first type. A first loss function compares the first training image to the second generated image. The method also includes obtaining a second training image of the second type and applying the second function to obtain a first generated image of the first type. The first function is applied to the first generated image to obtain a second generated image having the second type. A second loss function compares the second training image to the second generated image. At least one of the first or second function are updated based on an output of the first and second loss functions.

### CROSS-REFERENCE TO RELATED APPLICATIONS

This application claims priority to and benefit of U.S. Provisional Application No. 63/, filed Jul. 22, 2024, which is hereby assigned to the assignee hereof and hereby expressly incorporated by reference in their entirety as if fully set forth below and for all applicable purposes.

### BACKGROUND

This disclosure relates generally to generating images of an eye utilizing machine learning.

Multiple different types of imaging technologies can capture images of the eye, such as optical coherence tomography (“OCT”) or ultrasound bio-microscopy (“UBM”). OCT provides a noninvasive imaging technology using low-coherence interferometry to generate high-resolution images of an ocular structure. OCT imaging functions partly by measuring the echo time delay and magnitude of backscattered light. Images generated by OCT are useful for many purposes, such as identification and assessment of ocular diseases. An inherent limitation of OCT imaging is that the illuminating beam cannot penetrate across the iris. This leaves a peripheral portion of the lens blocked by the iris.

UBM is a noninvasive imaging technology that uses high-frequency ultrasound waves to visualize biological structures at microscopic resolutions. Images generated by UBM can penetrate the iris of the eye but are subject to a trade-off between penetration depth and resolution of the images generated.

### SUMMARY

Disclosed herein is a method of augmenting an image of an eye. The method includes obtaining a first training image of having a first image type and applying a first function to the first training image to obtain a first generated image of the first training image with the first generated image being of a second image type different from the first image type. A second function is applied to the first generated image of the first training image to obtain a second generated image of the first training image with the second generated image being of the first image type. A first loss function is utilized to compare the first training image to the second generated image of the first training image to determine the accuracy of the first function and the second function. At least one of the first function or the second function are updated based on an output of the first loss function. The method also includes obtaining a second training image having the second image type and applying the second function to the second training image to obtain a first generated image of the second training image with the first generated image of the second training image being of the first image type. The first function is applied to the first generated image of the second training image to obtain a second generated image of the second training image having the second image type. A second loss function is utilized to compare the second training image to the second generated image of the second training image to determine an accuracy of the first function and the second function. At least one of the first function or the second function are updated based on an output of the second loss function.

In one aspect of the disclosure the method includes utilizing the first function to transform an input image of a first image type into a generated image of the second image type.

In one aspect of the disclosure the first training image is obtained from a first imaging device and the second training image is obtained from a second imaging device.

In one aspect of the disclosure the first imaging device is an optical coherence tomography imaging device and the second imaging device is an ultrasound bio-microscopy imaging device.

In one aspect of the disclosure the first training image an optical coherence tomography image and the second training image includes an ultrasound bio-microscopy image.

In one aspect of the disclosure the first training image and the second training image are unpaired images.

In one aspect of the disclosure the method includes receiving an input optical coherence tomography image and transforming the optical coherence tomography image into a generated ultrasound bio-microscopy image with one of the first function or the second function.

In one aspect of the disclosure the method includes receiving an ultrasound bio-microscopy input image and transforming the input ultrasound bio-microscopy image into a generated ultrasound bio-microscopy image with one of the first function or the second function.

In one aspect of the disclosure the first training image is a distorted optical coherence tomography image and the second training image is an ultrasound bio-microscopy image that is paired with the distorted optical coherence tomography image.

In one aspect of the disclosure the method includes receiving an input distorted optical coherence tomography image and transforming the input distorted optical coherence tomography image into a generated distortion corrected optical coherence tomography image.

In one aspect of the disclosure the first training image is a preoperative optical coherence tomography image and the second training image is a postoperative optical coherence tomography image illustrating an intraocular lens that is paired with the preoperative optical coherence tomography image.

In one aspect of the disclosure the method includes receiving an input optical coherence tomography image and transforming the input optical coherence tomography image into a generated postoperative optical coherence tomography image illustrating an intraocular lens.

Disclosed herein is a method of utilizing an image prediction model. The method includes receiving an input image having a first image type and utilizing the image prediction model to transform the input image into a generated image of second image type. The image prediction model is developed by obtaining a first training image of having a first image type and applying a first function to the first training image to obtain a first generated image of the first training image with the first generated image being of a second image type different from the first image type. A second function is applied to the first generated image of the first training image to obtain a second generated image of the first training image with the second generated image being of the first image type. A first loss function is utilized to compare the first training image to the second generated image of the first training image to determine the accuracy of the first function and the second function. At least one of the first function or the second function are updated based on an output of the first loss function. The method also includes obtaining a second training image having the second image type and applying the second function to the second training image to obtain a first generated image of the second training image with the first generated image of the second training image being of the first image type. The first function is applied to the first generated image of the second training image to obtain a second generated image of the second training image having the second image type. A second loss function is utilized to compare the second training image to the second generated image of the second training image to determine an accuracy of the first function and the second function. At least one of the first function or the second function are updated based on an output of the second loss function.

In one aspect of the disclosure the first training image is an optical coherence tomography image and the second training image an ultrasound bio-microscopy image with the first training image and the second training image being unpaired images and the input image is an input optical coherence tomography image and the generated image is a generated ultrasound bio-microscopy image.

In one aspect of the disclosure the first training image is a distorted optical coherence tomography image and the second training image is an ultrasound bio-microscopy image that is paired with the distorted optical coherence tomography image and the input image is an input distorted optical coherence tomography image and the generated image is a generated distortion corrected optical coherence tomography image.

In one aspect of the disclosure the first training image is a preoperative optical coherence tomography image and the second training image is a postoperative optical coherence tomography image illustrating an intraocular lens that is paired with the preoperative optical coherence tomography image and the input image is an input optical coherence tomography image and the generated image is a generated postoperative optical coherence tomography image illustrating an intraocular lens.

Disclosed herein is a system for performing ophthalmic imaging. The system includes a first imaging device and a controller in communication with the first imaging device configured to receive an input image from the first imaging device having a first image type. The controller is also configured to utilize an image prediction model to transform the input image into a generated image of a second image type. The image prediction model is developed by obtaining a first training image of having a first image type and applying a first function to the first training image to obtain a first generated image of the first training image with the first generated image being of a second image type different from the first image type. A second function is applied to the first generated image of the first training image to obtain a second generated image of the first training image with the second generated image being of the first image type. A first loss function is utilized to compare the first training image to the second generated image of the first training image to determine the accuracy of the first function and the second function. At least one of the first function or the second function are updated based on an output of the first loss function. The method also includes obtaining a second training image having the second image type and applying the second function to the second training image to obtain a first generated image of the second training image with the first generated image of the second training image being of the first image type. The first function is applied to the first generated image of the second training image to obtain a second generated image of the second training image having the second image type. A second loss function is utilized to compare the second training image to the second generated image of the second training image to determine an accuracy of the first function and the second function. At least one of the first function or the second function are updated based on an output of the second loss function.

In one aspect of the disclosure the first training image is an optical coherence tomography image and the second training image an ultrasound bio-microscopy image with the first training image and the second training image being unpaired images and the input image is an input optical coherence tomography image and the generated image is a generated ultrasound bio-microscopy image.

In one aspect of the disclosure the first training image is a distorted optical coherence tomography image and the second training image is an ultrasound bio-microscopy image that is paired with the distorted optical coherence tomography image and the input image is an input distorted optical coherence tomography image and the generated image is a generated distortion corrected optical coherence tomography image.

In one aspect of the disclosure the first training image is a preoperative optical coherence tomography image and the second training image is a postoperative optical coherence tomography image illustrating an intraocular lens that is paired with the preoperative optical coherence tomography image and the input image is an input optical coherence tomography image and the generated image is a generated postoperative optical coherence tomography image illustrating an intraocular lens.

### BRIEF DESCRIPTION OF THE DRAWINGS

FIG. 1 is a schematic illustration of a system for augmenting an image of an eye, the system having a controller in communication with one or more imaging devices.

FIG. 2 is a schematic illustration of an example optical coherence tomography image of an eye.

FIG. 3 is a schematic illustration of an example ultrasound bio-microscopy image of an eye.

FIG. 4 is a schematic illustration of an example optical coherence tomography image of an eye having an intraocular lens implanted.

FIG. 5 is a flowchart of an example method executable by the controller of FIG. 1 to develop a machine-learning model for transforming images of an eye between different image types.

FIG. 6 is a flowchart of an example method executable by the controller of FIG. 1 for transforming an input image of an eye into another image type utilizing the machine learning model developed by the method of FIG. 5.

FIG. 7 is a schematic illustration of a generated ultrasound bio-microscopy image of an eye utilizing the example methods of FIGS. 5-6.

FIG. 8 is a schematic illustration of a generated optical coherence tomography image of an eye utilizing the example methods of FIGS. 5-6.

FIG. 9 is a schematic illustration of another generated optical coherence tomography image of the eye utilizing the example methods of FIGS. 5-6.

The foregoing and other features of the present disclosure are more fully apparent from the following description and appended claims, taken in conjunction with the accompanying drawings.

### DETAILED DESCRIPTION

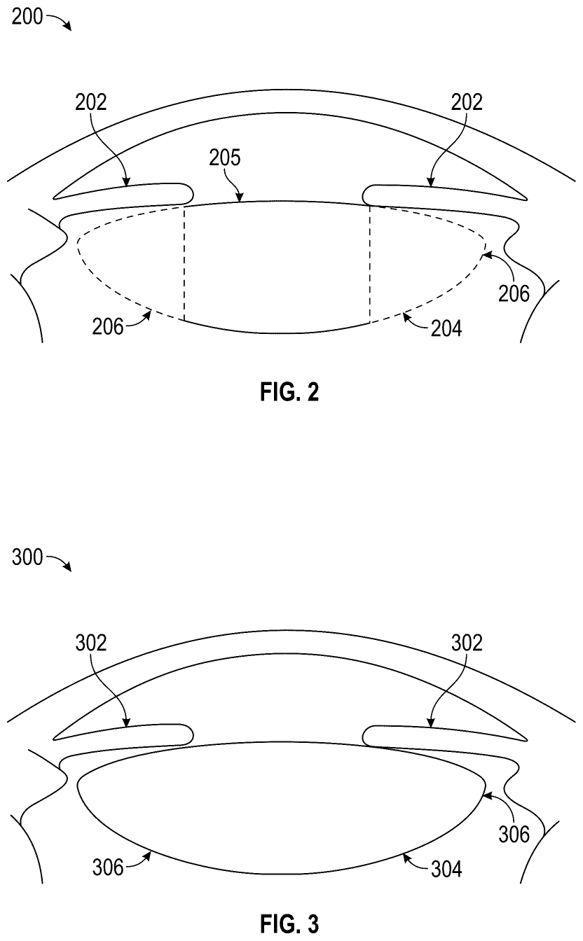

When performing ophthalmic procedures, an operator, such as a surgeon, a doctor, or a technician may obtain an image of an eye of the patient. Two types of common images to obtain of the patient's eye include an optical coherence tomography (“OCT” hereinafter) image or an ultrasound bio-microscopy (“UBM” hereinafter) image. Each of these image types has inherent benefits and limitations as discussed above. However, obtaining both OCT and UBM images of the patient's eye may not be possible due to only having access to a single imaging machine. Also, it is possible that the image, such as the OCT image, may be distorted or blurry such that measurements of the eye cannot be taken. As discussed in greater detail below with respect to FIGS. 2-3, one benefit of obtaining a UBM image over an OCT image is that the UBM image can visualize structures behind the iris of the eye. However, OCT images have the benefit of capturing images without contacting the eye.

One feature of this disclosure is to take an image of a first type and transform it into an image of a second type, such as transforming an OCT image into a UBM image, or vice versa. Similarly, this disclosure is applicable to improving image clarity in blurred images or performing distortion correction in distorted images of the eye. This allows images that would have previously been unsuitable for obtaining measurements of structures in the eye to be used for obtaining measurements. Furthermore, this disclosure applies to predicting postoperative images of the eye based on preoperative images as will be discussed in greater detail below.

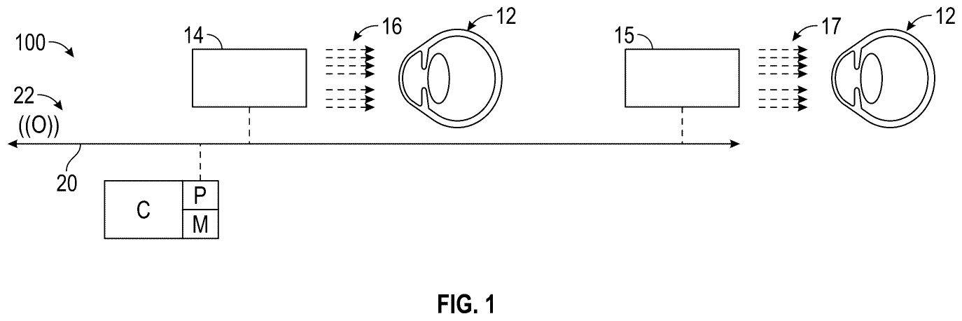

Referring to the drawings, wherein like reference numbers refer to like components, FIG. 1 schematically illustrates a system 100 for generating images of an eye 12. In the illustrated example, the system 100 includes the ability to capture images of the eye 12, such as an OCT image with an OCT device 14 or a UBM image with a UBM device 15. The OCT device 14 may employ an array of laser beams 16 for illuminating the eye 12. The array of laser beams 16 may cover the span or width of the eye 12. In one example, the OCT device 14 is an anterior segment high-definition OCT imaging device. It is to be understood that the OCT device 14 may take many different forms and include multiple and/or alternate components.

The UBM device 15 may employ an array of high-frequency ultrasonic waves 17 for penetrating into the eye 12. It is also to be understood that the UBM device 15 may take many different forms and include multiple and/or alternative components.

In FIG. 1, the eye 12 being scanned by the OCT device 14 and the UBM device 15 can be the same eye or a different eye. This will allow for the creation of paired or unpaired sets of image of the eye from the OCT device 14 and the UBM device 15. Also, paired and unpaired sets of images can be generated using just one of the OCT device 14 or the UBM device 15.

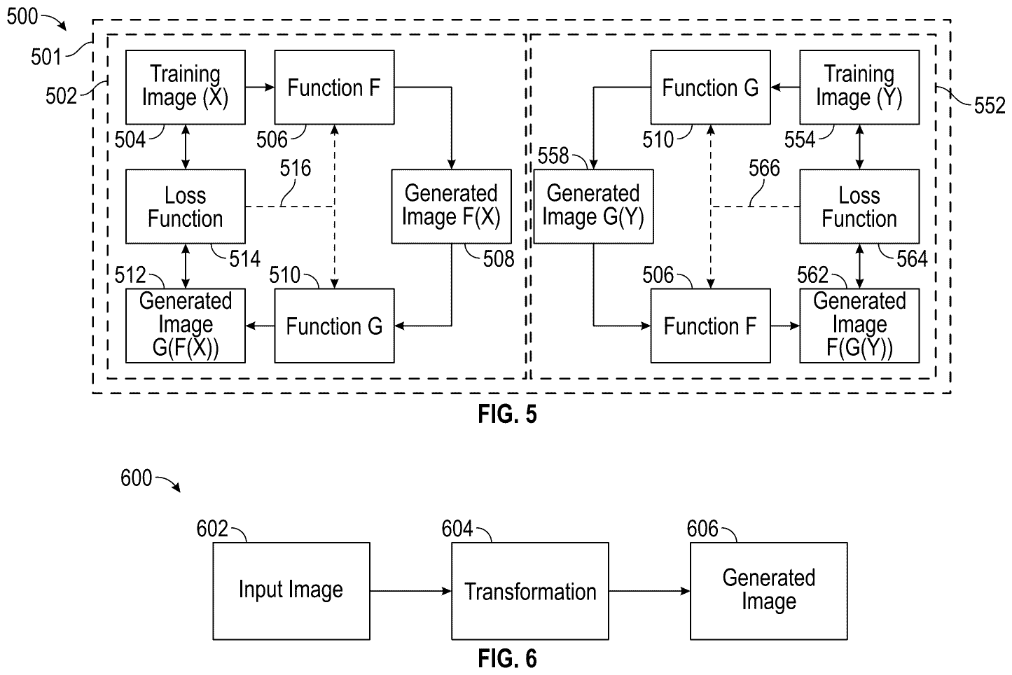

With continued reference to FIG. 1, the system 100 includes a controller C having at least one processor P and at least one memory M (or non-transitory, tangible computer-readable storage medium) on which instructions are recorded for executing at least one of a method 500 of developing a machine-learning model or a method 600 of transforming images between first and second types using the machine learning model developed by the method 500. The method 500 is shown in and described in greater detail below with reference to FIG. 5 and the method 600 is shown in and described in greater detail below with reference to FIG. 6.

The various components of the system 100 of FIG. 1 may communicate via a short-range network 20 and/or a long-range network 22. Accordingly, the OCT device 14 and the UBM device 15 do not need to be in the same physical location as the controller C. The short-range network 20 may be a bus implemented in various ways, such as for example, a serial communication bus in the form of a local area network. The local area network may include, but is not limited to, a Controller Area Network (CAN), a Controller Area Network with Flexible Data Rate (CAN-FD), Ethernet, Bluetooth, Wi-Fi and other forms of data connection. Referring to FIG. 1, the long-range network 22 may be a Wireless Local Area Network (LAN) which links multiple devices using a wireless distribution method, a Wireless Metropolitan Area Networks (MAN) which connects several wireless LANs or a Wireless Wide Area Network (WAN) which covers large areas such as neighboring towns and cities. Other types of connections may be employed.

FIG. 2 schematically illustrates an OCT image 200. The OCT image 200 can be utilized for training the method 500 or as an input image for transforming with the method 500 as will be discussed in greater detail below. In one example the OCT image 200 can include a distorted OCT image of the eye 12 or a distortion corrected image of the eye 12. In the illustrated example, the OCT image 200 displays an anterior segment view of the eye. Referring to FIG. 2, the OCT image 200 shows an iris 202, a lens 204, and a pupil 205. OCT imaging does not capture a peripheral portion 206 of the lens 204 that is behind the iris 202. This is because the illuminating lasers used in OCT imaging cannot penetrate across the iris 202. However, OCT imaging techniques provide high resolution and a non-contact scanning method that is convenient in terms of patients' compliance and comfort in daily clinical settings. For example, OCT imaging is performed in the sitting position, takes a relatively short amount of time, and does not involve the use of eyecups or coupling medium.

FIG. 3 schematically illustrates an example UBM image 300. The UBM image 300 may or may not be paired with a corresponding OCT image 200 as described above. The UBM image 300 shows the iris 302 and lens 304. The UBM image 300 also shows the peripheral portion 306 of the lens 304. The UBM image 300 can capture the entire crystalline lens structure of the eye 12 but at a lower resolution compared to the OCT image 200. However, capturing UBM images is less convenient for the patient because capturing UBM images requires longer image acquisition times, a skilled operator, and a plastic or silicone eyecup to hold a coupling medium.

FIG. 5 illustrates a flowchart of the method 500 of developing a machine learning model for transforming images between different image types. In the illustrated example, the machine learning model develops a first function 506 (Function F) and a second function 510 (Function G) for transforming images between an original or input image type to another image type depending on the types of images used to train the model. To perform this transformation, the method 500 utilizes a deep learning architecture known as a Generative Adversarial Network 501 (“GAN” hereinafter) to generate the first function 506 (Function F) and the second function 510 (Function G) based on a corresponding first training image type dataset having a set of images of type (X) and a corresponding second training image type dataset having a set of images of type (Y). In one example, the GAN is a CycleGAN.

When the first function 506 (Function F) and the second function 510 (Function G) are trained with the GAN 501, each can perform a transformation between different image types. For example, the first function 506 (Function F) can perform a transformation from the image type (X) to the image type (Y) and the second function 510 (Function G) can perform a transformation from the image type (Y) to the image type (X). By developing these functions, this disclosure can transform between different image types. This transformation can correct for image distortion, improve image resolution, or produce a generated postoperative image of the eye having an intraocular lens (“IOL”) implanted. Each of these example transformations will be discussed in greater detail below.

As shown in FIG. 5, the GAN 501 includes a first training portion 502 configured to receive a first training image (X) 504 of a first image type from the first training dataset. The first training image (X) 504 is provided to the first function 506 (Function F). The first function 506 (Function F) transforms the first training image (X) 504 into a first generated image 508 (“Generated Image F (X)”). The first generated image 508 is of a different image type than the first training image (X) 504 as will be discussed in greater detail below with respect to the disclosed examples. The first generated image 508 is provided to the second function 510 (Function G) and is transformed into a second generated image 512 (“Generated Image G(F(X))”). The second generated image 512 includes an image of the first type that is intended to match the first training image (X) 504.

A first loss function 514 evaluates how closely the second generated image 512 matches the training image (X) 504. The evaluation performed by the first loss function 514 generates an output 516 that is utilized to update parameters and weights of at least one of the first function 506 or the second function 510. The ability to update the first and second functions 506 and 510 in an iterative process improves the ability of the method 500 to have the second generated image 512 to match the first training image (X) 504 more closely with each iteration of the first training portion 502. Furthermore, a second training portion 552 of the GAN 501 provides an adversarial iterative approach that further refines the first and second functions 506 and 510 to improve their ability to create generated images.

The second training portion 552 of the GAN 501 provides a similar approach to training the first and second functions 506 and 510 as in the first training portion 502 but in an opposite direction. With the second training portion 552, a second training image (Y) 554 is provided to the second function 510 (Function G) and is transformed into a first generated image 558 (“Generated Image G(Y)”). The second training image (Y) 554 is of the same image type as the first generated image 508. The first generated image 558 is then provided to the first function 506 (Function F) and is transformed into a second generated image 562 (“Generated Image F(G(Y))”), which is of the same image type as the second training image (Y) 554.

A second loss function 564 evaluates how closely the second generated image 562 matches the second training image (Y) 554. The evaluation performed by the second loss function 564 generates an output 566 that is utilized to update parameters and weights of at least one of the first function 506 or the second function 510. The first and second training portions 502 and 552 functioning together provide the adversarial iterative refinement of the first and second functions 506 and 510 characteristic of a GAN.

FIG. 6 illustrates a method 600 that utilizes the first and second functions 506 and 510 developed by the method 500 to transform in input image of one type into a generated image of another type. In this disclosure, a generated image refers to an image created by one of the first or second functions 506 and 510 that was not captured by one of the OCT device 14 of the UBM device 15. The method 600 begins by receiving an input image 602 of the eye 12. A transformation 604 of the input image is performed by one of the first or second functions 506 and 510 to output a generated image 606. The generated image 606 is of a different type than the input image 602.

In one example, the generated image 606 from the method 600 can be a generated UBM image 700 that was transformed by one of the first or second functions 506 and 510 from the input image 602, such as the OCT image 200. For the method 600 to perform this transformation, the first training image (X) 504 from the first training dataset in the method 500 includes the OCT image 200 and the second training image (Y) 554 from the second training dataset in the method 500 includes the UBM image 300. In this example, the first and second training images 504 and 554 are not paired images but can be images of different eyes.

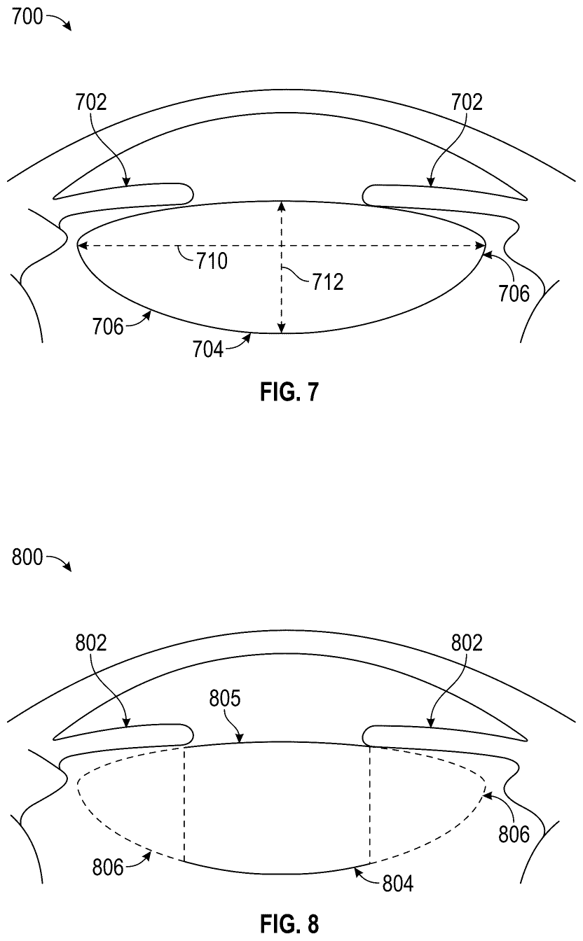

Accordingly, the method 500 utilizes the first training dataset comprised of the OCT images 200 as the first training image (X) 504 with the first training portion 502 and the second training dataset comprised of UBM images 300 as the second training image (Y) (554) with the second training portion 552. This results in the first function 506 (Function F) being able to transform the input OCT image into the generated UBM image 700. As shown in FIG. 7, the generated UBM image 700 illustrates the iris 702 and lens 704 with the peripheral portion 706. This allows measurements 710 and 712 to be taken from the lens 704 when only an OCT image 200 of the eye is available.

Conversely, the second function 510 (Function G) can transform an input UBM image into a generated OCT image 800. As shown in FIG. 8, the generated OCT image 800 illustrates an iris 802, a lens 804, and a pupil 805. The generated OCT image 800 does not capture a peripheral portion 806 of the lens 804 behind the iris 802. One feature of transforming the input UBM image into the generated OCT image 800 is improved resolution of structures of the eye in the generated OCT image 800 over the input UBM image.

In another example, the generated image 606 from the method 600 can be a generate distortion-corrected OCT image 800 that was transformed by one of the first or second functions 506 and 510 from the input image, such as OCT image 200 not having a distortion correction. For the method 600 to perform this transformation, the first training image (X) 504 from the first training dataset in the method 500 includes a distorted OCT image and the second training image (Y) 554 from the second training dataset includes distortion-corrected OCT image. In this example, the first training image (X) in the first training dataset and the second training image (Y) in the second training dataset are paired images showing a distorted OCT image and its corresponding distortion corrected version.

Accordingly, the method 500 utilizes paired images such that the first training dataset of the first training images (X) 504 includes distorted OCT images and the second training dataset of the second training images (Y) 554 includes corresponding distortion-corrected OCT images. This results in the first function 506 (Function F) transforming a distorted input OCT input image into a generated OCT image 800 (FIG. 8) that corrects for distortion in the input OCT image. This allows for measurements, such as a thickness of the lens to be taken from the lens of a patient's eye when just a distorted OCT image is available.

Conversely, the second function 510 (Function G) can transform an input distortion-corrected OCT image into a distorted OCT image, but his transformation is generally less desired in the art.

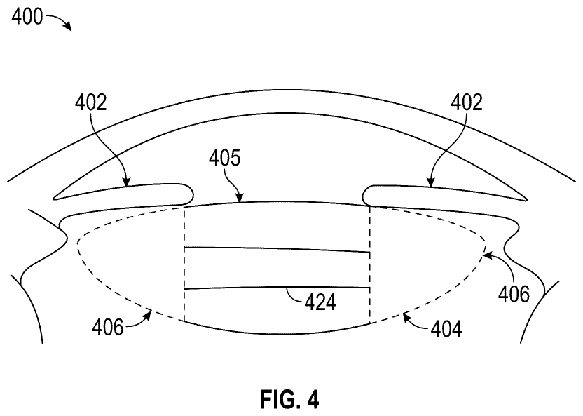

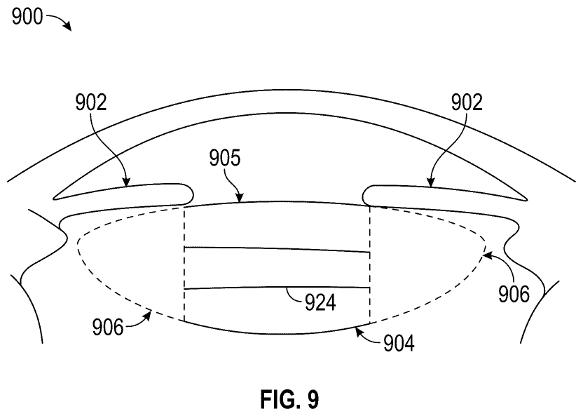

In yet another example, the generated image 606 from the method 600 can be a generated postoperative OCT image 900 (FIG. 9) having an IOL 924 that was transformed by one of the first or second functions 506 and 510 from the input image 602, such as the OCT image 200. For the method 600 to perform this transformation, the OCT image 200 is preoperative is used as the first training image (X) 504 from the first training dataset in the method 500 and a corresponding postoperative OCT image 400 (FIG. 4) is used as the second training image (Y) 554 from the second training dataset in the method 500. Furthermore, in this example, the OCT image 200 and the postoperative OCT images 400 are paired images such that the postoperative OCT image 400 corresponds to the same eye in the OCT image 200 that was taken preoperatively. As shown in FIG. 4, the postoperative OCT image 400 illustrates an iris 402, a lens 404, a pupil 405, and an IOL 424. The postoperative OCT image 400 does not capture a peripheral portion 406 of the lens 404 behind the iris 402.

Accordingly, the method 500 utilizes the first training dataset comprised of the OCT images 200 as the first training images (X) 504 with the first portion and the second training dataset comprised of postoperative OCT images 400 as the second training images (Y) 554 with the second training portion 552. This results in the first function 506 (Function F) being able to transform the input OCT image into a generated postoperative OCT image 900 (FIG. 9). As shown in FIG. 9, the generated postoperative OCT image 900 illustrates an iris 902, an artificial lens 904, and a pupil 905. The generated postoperative OCT image 900 does not capture a peripheral portion 906 of the lens 904 behind the iris 902. The generated postoperative OCT image 900 allows for the location, power, and refractive index to be determined for an IOL 924 in FIG. 9 prior to implantation.

Conversely, the second function 510 (Function G) can transform a postoperative OCT image into a generated preoperative OCT image. This transformation can be used as a verification utilizing a postoperative OCT image showing the IOL with the OCT device 14 and comparing it to the OCT image 200 captured of the same eye preoperatively.

The detailed description and the drawings are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims.

Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claim is:

1. A method of augmenting an image of an eye, the method comprising:
obtaining a first training image of having a first image type;
applying a first function to the first training image to obtain a first generated image of the first training image, wherein the first generated image is of a second image type different from the first image type;
applying a second function to the first generated image of the first training image to obtain a second generated image of the first training image, wherein the second generated image is of the first image type;
utilizing a first loss function to compare the first training image to the second generated image of the first training image to determine an accuracy of the first function and the second function;
updating at least one of the first function or the second function based on an output of the first loss function;
obtaining a second training image having the second image type;
applying the second function to the second training image to obtain a first generated image of the second training image, wherein the first generated image of the second training image is of the first image type;
applying the first function to the first generated image of the second training image to obtain a second generated image of the second training image having the second image type;
utilizing a second loss function to compare the second training image to the second generated image of the second training image to determine an accuracy of the first function and the second function; and
updating at least one of the first function or the second function based on an output of the second loss function.

2. The method of claim 1, including utilizing the first function to transform an input image of a first image type into a generated image of the second image type.

3. The method of claim 1, wherein the first training image is obtained from a first imaging device and the second training image is obtained from a second imaging device.

4. The method of claim 3, wherein the first imaging device is an optical coherence tomography imaging device and the second imaging device is an ultrasound bio-microscopy imaging device.

5. The method of claim 1, wherein the first training image is an optical coherence tomography image and the second training image includes an ultrasound bio-microscopy image.

6. The method of claim 5, wherein the first training image and the second training image are unpaired images.

7. The method of claim 6, including receiving an input optical coherence tomography image and transforming the optical coherence tomography image into a generated ultrasound bio-microscopy image with one of the first function or the second function.

8. The method of claim 6, including receiving an ultrasound bio-microscopy input image and transforming the input ultrasound bio-microscopy image into a generated ultrasound bio-microscopy image with one of the first function or the second function.

9. The method of claim 1, wherein the first training image is a distorted optical coherence tomography image and the second training image is an ultrasound bio-microscopy image that is paired with the distorted optical coherence tomography image.

10. The method of claim 9, including receiving an input distorted optical coherence tomography image and transforming the input distorted optical coherence tomography image into a generated distortion corrected optical coherence tomography image.

11. The method of claim 1, wherein the first training image is a preoperative optical coherence tomography image and the second training image is a postoperative optical coherence tomography image illustrating an intraocular lens that is paired with the preoperative optical coherence tomography image.

12. The method of claim 11, including receiving an input optical coherence tomography image and transforming the input optical coherence tomography image into a generated postoperative optical coherence tomography image illustrating an intraocular lens.

13. A method of utilizing an image prediction model, the method comprising:
receiving an input image having a first image type;
utilizing the image prediction model to transform the input image into a generated image of second image type, wherein the image prediction model is developed by:
obtaining a first training image of having the first image type;
applying a first function to the first training image to obtain a first generated image of the first training image, wherein the first generated image is of a second image type different from the first image type;
applying a second function to the first generated image of the first training image to obtain a second generated image of the first training image, wherein the second generated image is of the first image type;
utilizing a first loss function to compare the first training image to the second generated image of the first training image to determine an accuracy of the first function and the second function;
updating at least one of the first function or the second function based on an output of the first loss function;
obtaining a second training image having the second image type;
applying the second function to the second training image to obtain a first generated image of the second training image, wherein the first generated image of the second training image is of the first image type;
applying the first function to the first generated image of the second training image to obtain a second generated image of the second training image having the second image type;
utilizing a second loss function to compare the second training image to the second generated image of the second training image to determine an accuracy of the first function and the second function; and
updating at least one of the first function or the second function based on an output of the second loss function.

14. The method of claim 13, wherein the first training image is an optical coherence tomography image and the second training image an ultrasound bio-microscopy image with the first training image and the second training image being unpaired images and the input image is an input optical coherence tomography image and the generated image is a generated ultrasound bio-microscopy image.

15. The method of claim 13, wherein the first training image is a distorted optical coherence tomography image and the second training image is an ultrasound bio-microscopy image that is paired with the distorted optical coherence tomography image and the input image is an input distorted optical coherence tomography image and the generated image is a generated distortion corrected optical coherence tomography image.

16. The method of claim 13, wherein the first training image is a preoperative optical coherence tomography image and the second training image is a postoperative optical coherence tomography image illustrating an intraocular lens that is paired with the preoperative optical coherence tomography image and the input image is an input optical coherence tomography image and the generated image is a generated postoperative optical coherence tomography image illustrating an intraocular lens.

17. A system for performing ophthalmic imaging, the system comprising:
a first imaging device;
a controller in communication with the first imaging device configured to:
receive an input image from the first imaging device having a first image type;
utilize an image prediction model to transform the input image into a generated image of a second image type, wherein the image prediction model is developed by:
obtaining a first training image of having the first image type;
applying a first function to the first training image to obtain a first generated image of the first training image, wherein the first generated image is of a second image type different from the first image type;
applying a second function to the first generated image of the first training image to obtain a second generated image of the first training image, wherein the second generated image is of the first image type;
utilizing a first loss function to compare the first training image to the second generated image of the first training image to determine an accuracy of the first function and the second function;
updating at least one of the first function or the second function based on an output of the first loss function;
obtaining a second training image having the second image type;
applying the second function to the second training image to obtain a first generated image of the second training image, wherein the first generated image of the second training image is of the first image type;
applying the first function to the first generated image of the second training image to obtain a second generated image of the second training image having the second image type;
utilizing a second loss function to compare the second training image to the second generated image of the second training image to determine an accuracy of the first function and the second function; and
updating at least one of the first function or the second function based on an output of the second loss function.

18. The system of claim 17, wherein the first training image is an optical coherence tomography image and the second training image an ultrasound bio-microscopy image with the first training image and the second training image being unpaired images and the input image is an input optical coherence tomography image and the generated image is a generated ultrasound bio-microscopy image.

19. The system of claim 17, wherein the first training image is a distorted optical coherence tomography image and the second training image is an ultrasound bio-microscopy image that is paired with the distorted optical coherence tomography image and the input image is an input distorted optical coherence tomography image and the generated image is a generated distortion corrected optical coherence tomography image.

20. The system of claim 17, wherein the first training image is a preoperative optical coherence tomography image and the second training image is a postoperative optical coherence tomography image illustrating an intraocular lens that is paired with the preoperative optical coherence tomography image and the input image is an input optical coherence tomography image and the generated image is a generated postoperative optical coherence tomography image illustrating an intraocular lens.
